(19) United States
(12) Patent Application Publication
(10) Pub. No.: US 2014/0144042 A1
(43) Pub. Date: May 29, 2014

(54) FURNACE INCLUDING MULTIPLE TRAYS AND PHASE-CHANGE HEAT TRANSFER

(71) Applicants: Mark Wechsler, San Mateo, CA (US); Chad Wall, Livermore, CA (US); John Whitney, El Dorado, AR (US); Jim Hamilton, Sunnyvale, CA (US)

(72) Inventors: Mark Wechsler, San Mateo, CA (US); Chad Wall, Livermore, CA (US); John Whitney, El Dorado, AR (US); Jim Hamilton, Sunnyvale, CA (US)

(21) Appl. No.: 13/906,198

(22) Filed: May 30, 2013

Related U.S. Application Data
(60) Provisional application No. 61/654,014, filed on May 31, 2012.

(51) Int. Cl. F26B 21/08

(52) U.S. Cl. CPC F26B 21/08
USPC 34/468; 34/73

(57) ABSTRACT

A method and apparatus for heating materials is described. The apparatus is a furnace that includes multiple gravity-feed trays and a heat transfer fluid that heats material by the heat evolved during phase change. The apparatus also includes moving paddles that urge the material through each tray. The method provides for the torrefying of the material using a phase-change heat-transfer fluid by providing the material sequentially to at least two trays, where the at least two trays are substantially horizontal and disposed at different vertical heights; condensing the vapor phase at a temperature; and providing heat from the condensing the vapor phase to the material, where the temperature is sufficient to torrefy the material.

### CROSS-REFERENCE TO RELATED APPLICATIONS

This application claims the benefit of U.S. Provisional Application No. 61/654,014, filed May 31, 2012, hereby incorporated by reference in its entirety.

### BACKGROUND OF THE INVENTION

1. Field of the Invention

The present invention generally relates to dryers, and more particularly to a method and system for drying solid material

2. Discussion of the Background

Existing dryers and roasters either transfer heat directly (when the heat transfer medium is in contact with and mixes with the process materials and products), or indirectly (when the heat exchange medium remains separated from the process materials and process products).

The direct heating approach benefits from low thermal resistance and high surface area contact, often with high driving temperatures. If the heat transfer medium is hot air, the risk of fire or partial combustion exists, placing limits on the driving temperature. These limits may be overcome by either using an inert gas or oxygen depleted combustion gas as the heat transfer medium; however this leads to a more complicated system.

In any case, the gases produced, which includes steam and combustible gases, are mixed with the heat exchange medium. A combustion system to use the chemical energy in the gases (to create process heat) becomes problematic because of the low Btu value of the mixed gas.

The indirect heating approach benefits from the high Btu value of the produced gases, having not been diluted into the heat transfer medium. This allows the gases to be combusted at high temperatures, ultimately providing a superior heating source. The process materials are more easily kept in an oxygen depleted or oxygen free environment.

Thus there is a need in the art for a method and apparatus that permits the more efficient use of material and energy in the drying of solid materials. Such a method and apparatus should be compact, easy to control, and be relatively maintenance-free.

### BRIEF SUMMARY OF THE INVENTION

The present invention overcomes the disadvantages of prior art by using a furnace that utilizes a phase-change heat transfer fluid to heat a material.

It is one aspect of the present invention to provide a furnace having an input adapted to accept a material to be processed, an output adapted to provide processed material. The furnace includes a first volume and a second volume. The first volume contains a fluid, where the fluid is a phase-change heat-transfer fluid, and where the fluid includes a vapor of the fluid and a liquid of the fluid. The second volume contains the material to be processed. The first volume and the second volume have a separating wall that is a fluid barrier between the first volume and the second volume and which provides for heat transfer between condensing vapor of the fluid and material contained within the second volume. The second volume includes at least two trays, where said at least two trays are substantially horizontal and disposed at different vertical heights, and at least one passageway between two of said at least two trays.

It is another aspect of the present invention to provide a method of torrefying a material using a fluid, where the fluid is a phase-change heat-transfer fluid and includes a liquid phase of the fluid and a vapor phase of the fluid. The method includes providing the material sequentially to at least two trays, where said at least two trays are substantially horizontal and disposed at different vertical heights; condensing the vapor phase at a temperature; and providing heat from said condensing the vapor phase to the material. The temperature is sufficient to torrefy the material.

These features together with the various ancillary provisions and features which will become apparent to those skilled in the art from the following detailed description, are attained by the furnace of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a schematic of a first embodiment furnace;

FIG. 2 is a perspective view of the furnace of FIG. 1;

FIG. 3 is a sectional view 3-3 of a first embodiment heater and vaporizer of FIG. 2;

FIG. 4 is a sectional view 4-4 of the heater and vaporizer of FIG. 3;

FIG. 5 is a detailed view of the heater of FIG. 3;

FIG. 6 is a sectional view 6-6 of a heater tray of FIG. 5;

FIG. 7 is a sectional view 7-7 the region between two heater trays of FIG. 5;

FIG. 8 is a sectional view 8-8 of a heater tray of FIG. 5;

FIG. 9 is a sectional view 9-9 the region between two heater trays of FIG. 5;

FIG. 10 is an exploded sectional view of a portion of the heater of FIG. 3; and

FIGS. 11A and 11B are a top and side view, respectively, of the paddle of the heater tray of FIG. 6;

FIGS. 11C and 11D are a top and side view, respectively, of the paddle of the heater tray of FIG. 8; and

FIG. 12 is a sectional view 12-12 of the vaporizer of FIG. 4.

Reference symbols are used in the Figures to indicate certain components, aspects or features shown therein, with reference symbols common to more than one Figure indicating like components, aspects or features shown therein.

### DETAILED DESCRIPTION OF THE INVENTION

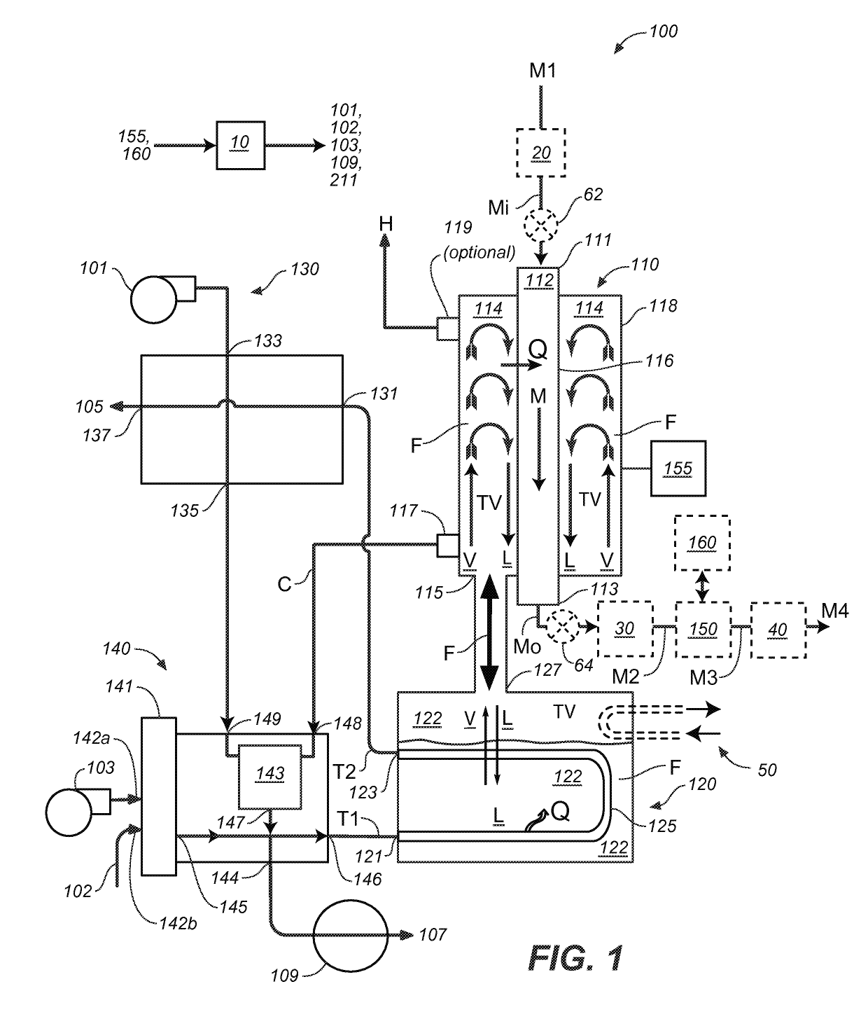

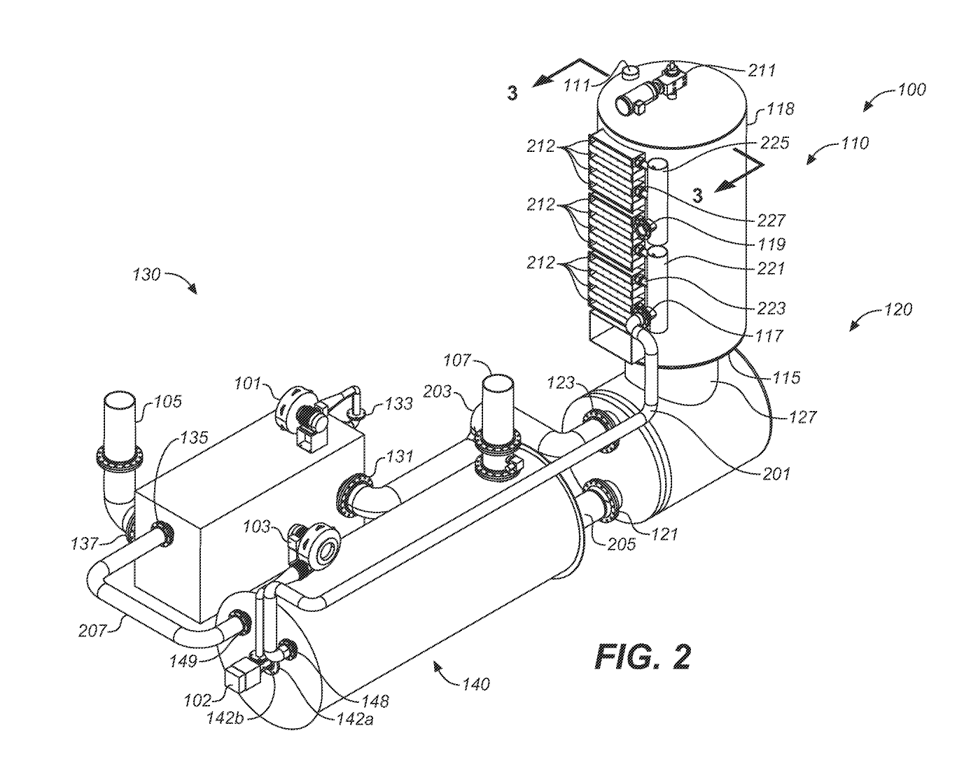

FIGS. 1 and 2 are a schematic and a perspective view, respectively, of a first embodiment furnace 100, which includes a heater 110, a vaporizer 120, a preheater 130, and a heat source 140. Furnace 100 also includes a first blower 101 to provide air to preheater 130, a second blower 103 to provide auxiliary air to heat source 140, and several outputs through which gases exit to the environment: a first stack 105 for reaction products from preheater 130, a second stack 107 for reaction products from heat source 140, and an optional port 119 for primarily humid air from heater 110.

Furnace 100 is particularly well suited to the heating of material M at a controlled temperature and environment. The material is shown as an input and output to heater 110 as an input Mi and an output Mo, respectively. Examples of material M include, but are not limited to, forest product residuals, agricultural residuals, and foodstuffs (ie. raw, coffee beans, cocoa, grains, etc.). The processed (heated) material may be used in a variety of uses including, but not limited to biofuels, filler for plastics, or food products. In certain embodiments, material M is processed to drive off volatile compounds that have a heating value that may be used to drive the processing of the material.

FIG. 1 also illustrates that furnace 100 may include other optional devices that are shown, without limitation, as one or more of dryer 20, coolers 30 or 40, press 150, heat transfer loop 50, one or more load locks 62, 64 and diagnostics 160. Examples of dryers and coolers used in the processing of material M, are shown, for example and without limitation, in co-owned U.S. patent application Ser. No. 13/221,497 filed on Aug. 30, 2011 and published as United States Patent Publication No. 2012-0117815 (the '497 application), U.S. patent application Ser. No. 13/042,356 filed on Mar. 7, 2011 and published as United States Patent Publication No. 2011-0214343 (the '356 application), and U.S. patent application Ser. No. 12/576,157 filed on Oct. 8, 2009 and published as United States Patent Publication No. 2010-0101141 (the '157 application), the contents of which are hereby incorporated by reference.

Thus, for example and without limitation: dryer 20 of the present application could be dryer reactor 320 of the '157 application, biomass dryer 310 of the '356 or '497 applications; cooler 30 or 40 of the present application could be cooling reactor 340 of the '157 application, biomass cooler 330 of the '356 or '497 applications; press 150 of the present application could be pelletizer 350 of the '157 application, biomass cooler 330 biomass compression portion 340 of the '356 or '497 applications. Furnace 100 may also include additional processing equipment, such as a load-lock to maintain material within volume 112 at a pressure that is higher or lower than atmospheric pressure and as discussed in the '157, '356, and '497 applications, a biomass preparation portion 301 and/or a biomass metering portion 303 of the '356 or '497 applications.

Material M is indicated at different states or conditions as M1, M2, M3, and M4. When dryer 20 is present, M1 is the input material and Mi is the dried input material. Mo is the heated (torrefied) material, when cooler 30 or 40 are present, M2 or M4 are cooled torrefied material, respectively, and if press 150 is present M3 is densified material. When load locks 62 and/or 64 are present, the pressure P in volume 112 may be greater than or less than atmospheric pressure

Heater 110 has an outer shell 118 that includes two internal volumes: a volume 112 for conducting a material M, and a volume 114 for containing a heat exchange fluid F. A common wall 116 between volumes 112 and 114 separates the volumes. In general, a material M may be provided to a material input 111, which passes through volume 112 to a material output 113, from which heated material M exits furnace 100. Heat transfer fluid F contained within volume 114 conducts heat through wall 116 to heat, react, or torrefy a material M passing through volume 112.

Heater 110 also includes a port 115 for the transfer, both into and from volume 114, of heat exchange fluid F, and a port 117 in fluid communication with volume 112 (and not volume 114) for the exiting of combustible gases from the heated material. Optional port 119 is also in fluid communication with volume 112 (and not volume 114) to transport gases that are primarily humid air from heated material M.

As shown in FIG. 2, heater 110 also includes a number of ports 212 that provide access to the volume 112, where the ports may be used to clean and/or service volume 112. As shown in FIG. 2, several ports 212 are connected by pipes 225 and 227 to port 119 and several other ports 212 are connected by pipes 221 and 223 to port 117. In certain embodiment, port 119 accumulates gases from the initial heating of material M, which consist primarily of humid air, and port 117 accumulates gases from the later heating of the material, where those gases consist primarily of volatile gases having some heating value which is extracted in heat source 140.

Heat exchange fluid F is preferably a phase-change fluid that may be in either a vapor phase V or a liquid phase L. In one embodiment, heat exchange fluid F is DOWTHERM™ A (Dow Chemical Company, Midland, Mich.), an organic heat transfer fluid that is a eutectic mixture of biphenyl (C₁₂H₁₀) and diphenyl oxide (C₁₂H₁₀O). The saturated DOWTHERM™ A vapor has a temperature that ranges from 205° C. at 0.28 atmosphere, 260° C. at one atmosphere, and 305° C. at 2.6 atmospheres of pressure. In a second embodiment, heat exchange fluid F is a parafin fluid, ie. XCELTHERM® XT (Radco Industries, Batavia, Ill.). XCELTHERM® XT can be used for higher temperatures, as it has a higher temperature than DOWTHERM™ A at the same vapor pressure.

In one embodiment, the pressure PV within volumes 114 and 122 is maintained so that the temperature TV can achieve the proper temperature for material M within volume 112. Heater 100 may include diagnostics 155 that may be used to monitor the pressure and temperature of fluid F within volume 114. As shown schematically in FIG. 1, heat exchange fluid F from port 115 includes vapor V that rises within volume 114, condenses on wall 116, and transfers heat Q through the wall into volume 112, and thus material M flowing there through. Thus, for example and without limitation, torrefaction of agricultural waste products torrefy in a temperature range of 200° C. to 350° C. By maintaining the pressure of PV DOWTHERM™ A at a pressure of 2.6 bars absolute, and a temperature of 305° C., and heat Q will be transferred into material M in volume 112 at that temperature. If it is determined that the temperature TV is too high for example, then pressure PV can be lowered to lower the vapor temperature of fluid F.

Heat source 140 has inputs that supply various gases that are reacted with the heat source and outputs that provide hot, reacted gases. In one embodiment heat source 140 provides gases to a thermal oxidizer 143 via an air intake port 149 and a combustible gas intake port 148. The oxidized gases exit the thermal oxidizer at an output 147. In another embodiment heat source 140 provides gases to a burner 141 via an auxiliary air input port 142a that accepts air from blower 103 and an auxiliary fuel input 142b that accepts fuel from an auxiliary fuel source 102. The combusted gases exit burner 131 at an output 145. Gases from outputs 145 and 147 are combined and exit heat source 140 at output port 146. The combined outputs 145 and 147 also exit heat source 140 at a second output port 144. The flow through second output port 144 is controlled by valve 109 and exits furnace 100 via stack 107. The gas provided by output port 146 and 144 may thus include reaction products of the thermally oxidized combustible gases and the combusted auxiliary fuel.

The heat source 140 may, for example and without limitation, be the combined thermal oxidizer/burner fabricated by Clark Griffith Consulting, of Lansdale, Pa. This device includes both burner 141 and thermal oxidizer 143 in one package, allowing for start-up or extra operating temperature with an alternative fuel source 102 (i.e. propane),

Vaporizer 120 accepts hot gas at a temperature T1 from output port 146 into an input port 121 and through tubing 125 before exiting the vaporizer at exit port 123 at a lower temperature, T2. Vaporizer 120 also includes a volume 122 separate from tubing 125, which contains a heat exchange fluid F. Volume 122 is in fluid communication with volume 114 of the heater, through ports 115 and 127, to allow liquid L and vapor V to flow between heater 110 and vaporizer 120.

A lower portion of volume 122 includes liquid phase L, and an upper portion of volume 122 includes a combination of liquid phase L and vapor phase V. The gases within tubing 125 provide heat Q to heat liquid L, causing a portion of the liquid to vaporize into vapor V. Heat provided by conduction from the hot gas provided at input port 121 heats the liquid L, which vaporizes at a temperature Tv determined by the pressure of within volume 122 and 114 according to the thermal properties of fluid F. Vapor V in volume 114 condenses on wall 116, providing heat by conduction at approximately the vaporization temperature Tv of fluid F.

Preheater 130 has an input port 131 for accepting gas from exit port 123 of vaporizer 120, an input port 133 for accepting air from a blower 101, an exit port 137 that provides gas to a stack 105 that exits furnace 100, and an exit port 135. Preheater 130 is a heat exchanger that recovers heat not used by vaporizer 120 to preheat air that is provided to thermal oxidizer 143.

Preheater 130 may be, for example and without limitation, a flat plate heat exchanger, which is well known in the field, and are manufactured, for example, by Southwest Thermal Technology, Inc, Camarillo, Calif.

In alternative embodiments, energy may be removed from furnace 100 for other processing or energy production uses. Thus, for example, stack 107 may be replaced with a device for recovering thermal energy and/or optional cooling loop 50 through vapor V may remove heat from fluid F at a temperature TV. Such heat may be used as process heat, as through a heat exchanger, or may be used for generating electricity or mechanical work, as in the power generator 230 of the '356 application, which may include a Rankine cycle (OCR) engine model UTC 2800, manufactured by UTC Power (United Technologies Corporation, South Windsor, Conn.), or a turbine.

FIG. 2 shows the connections between various components. Thus, FIG. 2 shows pipe 201, which connects port 117 with port 148, pipe 203, which connects port 131 to port 123, pipe 205, which connects port 146 and 121, pipe 207, which connects port 135 to port 149, paddle drive 211, and access ports 212. The various blowers, valves, and piping are sized to accommodate the flow of materials and temperatures required.

The heat exchange fluid is contained within a closed, constant volume within heater 110 and vaporizer 120 and does not mix with either the material that passes though heater 110 or gases from heat source 140. Furnace 100 thus provides for the indirect heating of material, where the temperature is controlled though the uses of a phase-change heat exchange fluid.

Furnace 100 may, in certain embodiments, provide material M to a press 150 to compact the heated material. Press 150 may, for example and without limitation, be an extrusion press. As an example, the heated material from output 113 may be first ground, if necessary, to pieces on the order of, for example and without limitation, 5 mm, and subsequently be fed into a screw press, where the material is extruded to the desired format, which may be, for example and without limitation, between 25 mm and 100 mm in diameter. The heated material may then be cooling and stored. By properly coordinating the speed of the extrusion screw with the process material flow, the extrusion screw remains full and the process output is sealed from the environment.

In certain other embodiments, diagnostics 160 may be utilized to monitor the material before, during or after pressing. Diagnostics 160 may, for example and without limitation, utilize spectroscopy to monitor the densified material M3. Examples of such a diagnostic technique are described, for example and without limitation, in the “'497 application, which describes a method of measuring the fuel value and other physical properties of the process products(s) using IR spectroscopy. Thus, for example, an Attenuated Total Reflectance (ATR) crystal may be positioned in the extrusion barrel. The process material is forced against the crystal, and an IR spectrometer continuously records the spectrum. This information may be used to control the process and to provide continuous process history.

Furnace 100 may also include a computer or other electronic control system 10. System 10 includes inputs from diagnostics 155 and 160 to acquire data concerning heat transfer fluid F (that is, the pressure Pv and temperature Tv of fluid F within volume 114), and processed material M, such as the density, temperature of processed material M, including data from diagnostics 160 Other process information can be made available to the system 10, including but not limited to, data from an emission analyzer system, (ie. ENERAC of Holbrook, N.Y.) which may include excess Oxygen, CO2 and total combustible gases as measured in stack 107 and/or 105. Thermocouples and pressure sensors, well known in the art, can be located at various process positions and made accessible to system 10. System 10 may then provide control signals to blowers 101 and 103, value 109, auxiliary fuel source 102, and paddle drive 211.

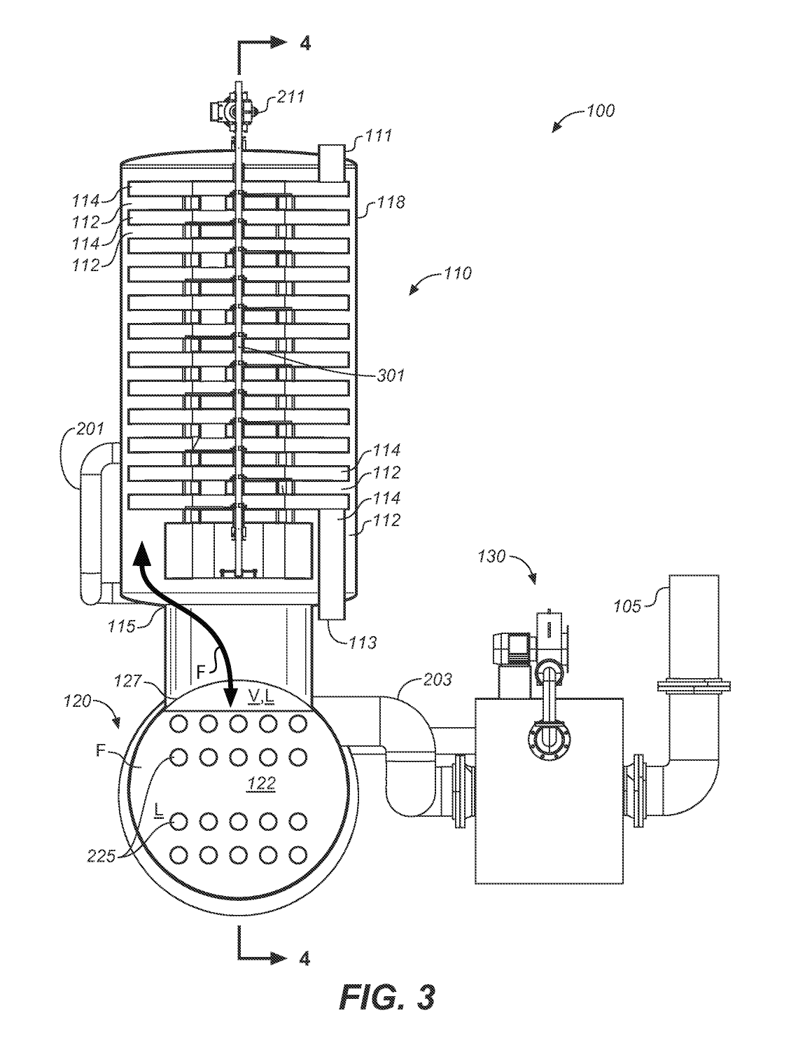

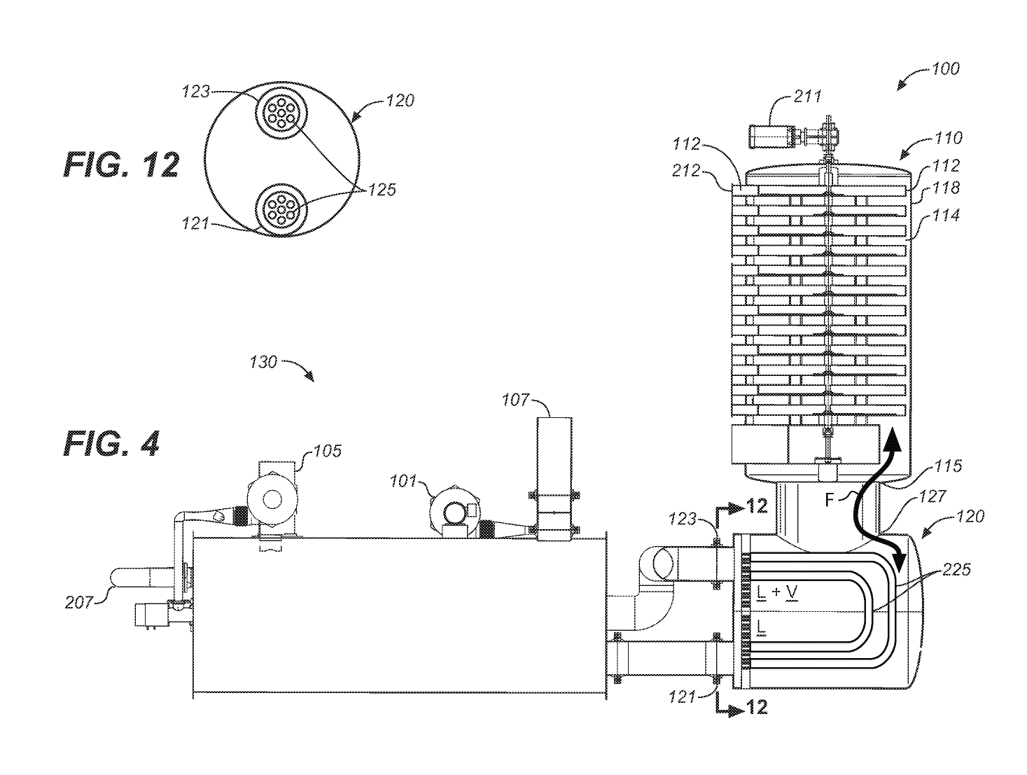

Details of heater 110 and vaporizer 120 are now described in greater detail, where FIG. 3 is a sectional view 3-3 of a first embodiment heater and vaporizer of FIG. 2, and FIG. 4 is a sectional view 4-4 of the heater and vaporizer of FIG. 3. As described subsequently in greater detail, heater 110 includes an alternating structure of volumes 112 and 114 to facilitate mixing of material M moving through volume 112 and heat transfer between material M and heat exchange fluid F. Paddle drive 211 is attached to a shaft 301 that also facilitates mixing of the material within volume 112.

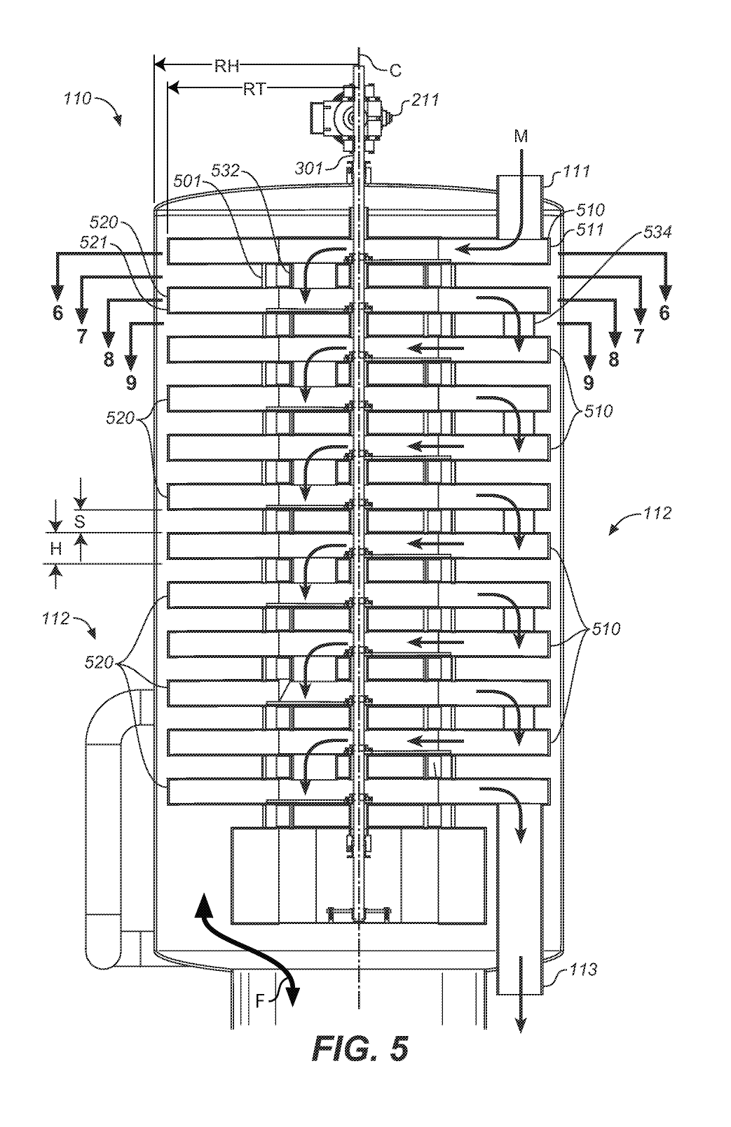

Heater 120 is shown in greater detail in FIG. 5 as a detailed view of the heater of FIG. 3. Volume 112 includes horizontal trays 510 and 520, which form wall 116, and that are alternately arranged vertically and connected by vertical passageways 532, 534. Trays 510 and 520 are generally circular with an outer perimeter 511, 521, respectively, and centerline near or on a centerline C of shaft 301. Material is provided to each tray 510 from passageway 534 (or input 111) near outer perimeter 511, and exits the tray closer to centerline C into passageway 532. Material then enters tray 520, and exits the tray near the outer perimeter 521 to passageway 534. The material thus flows back and forth, from input 111 to output 113.

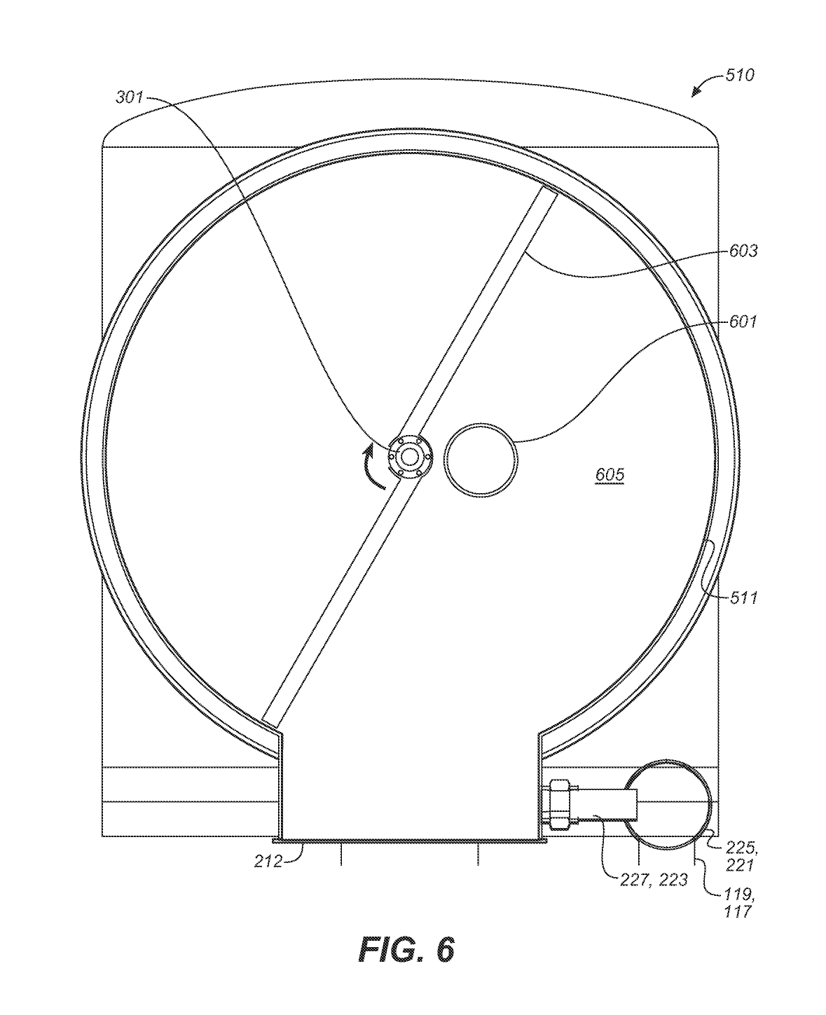

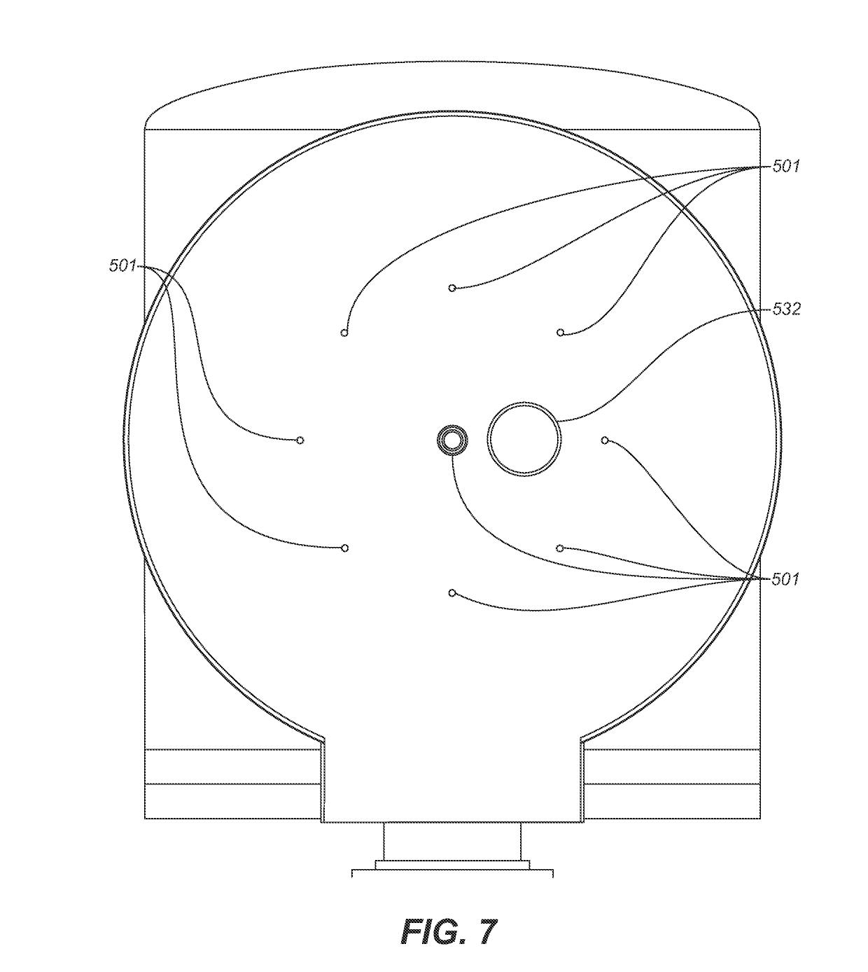

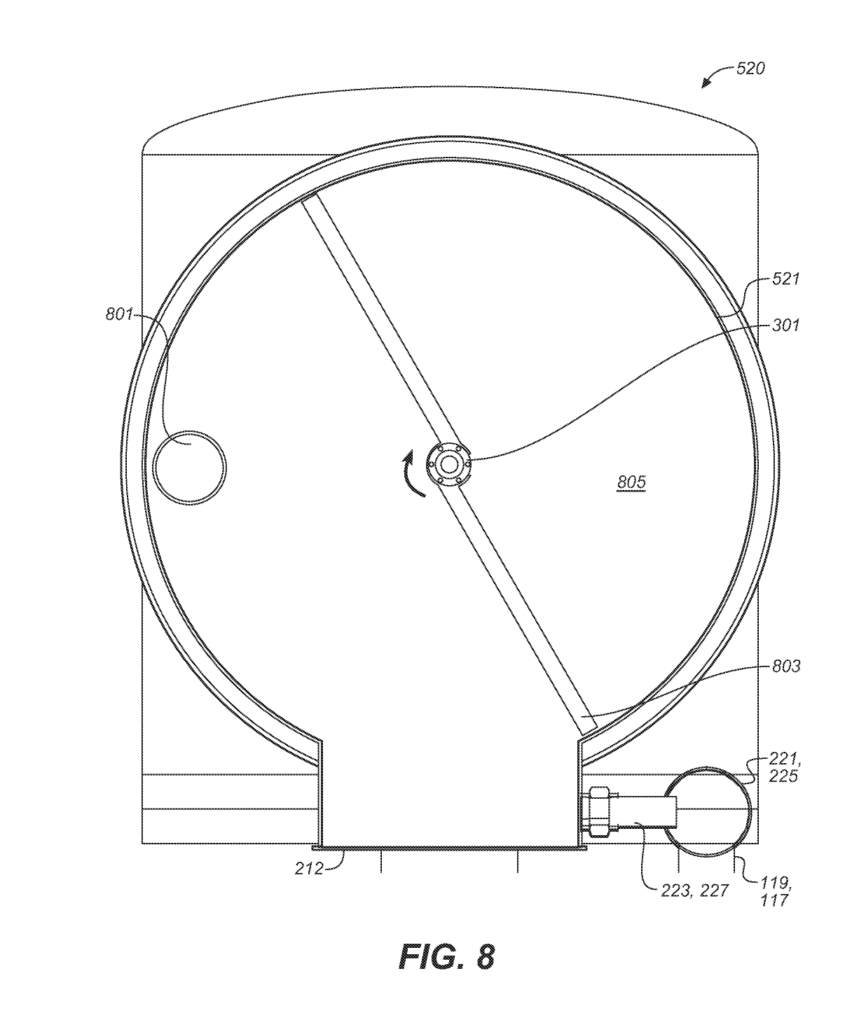

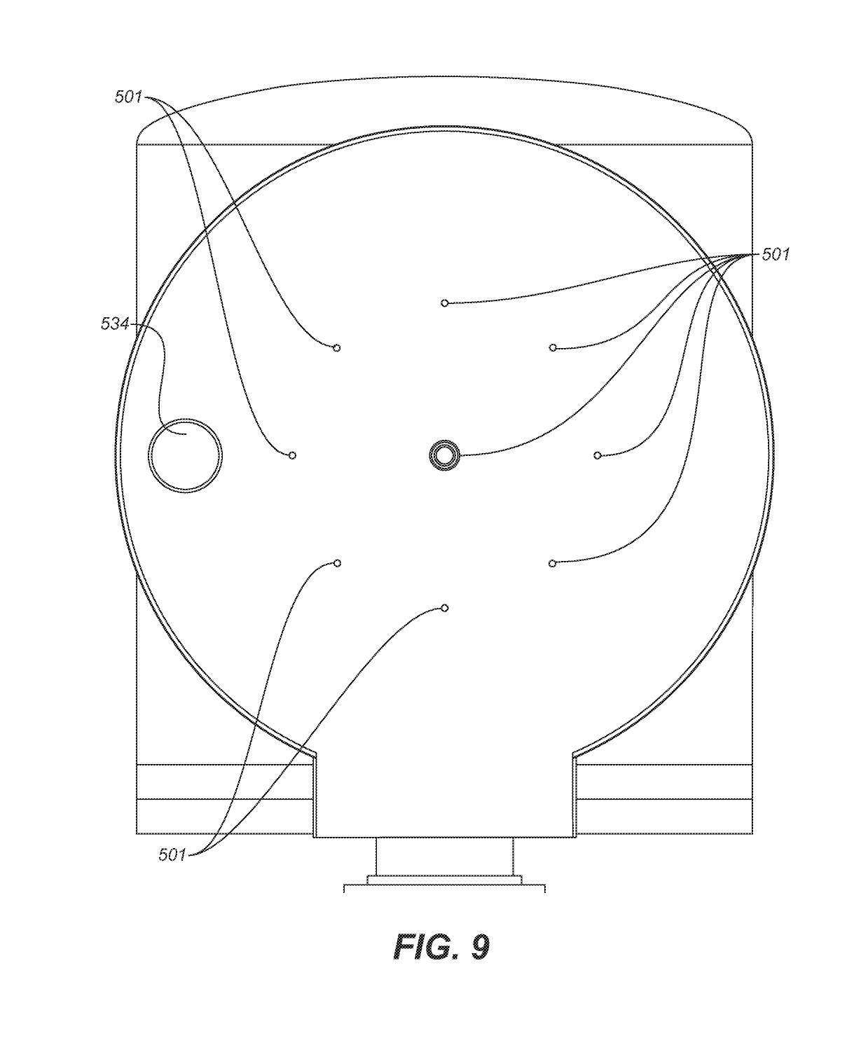

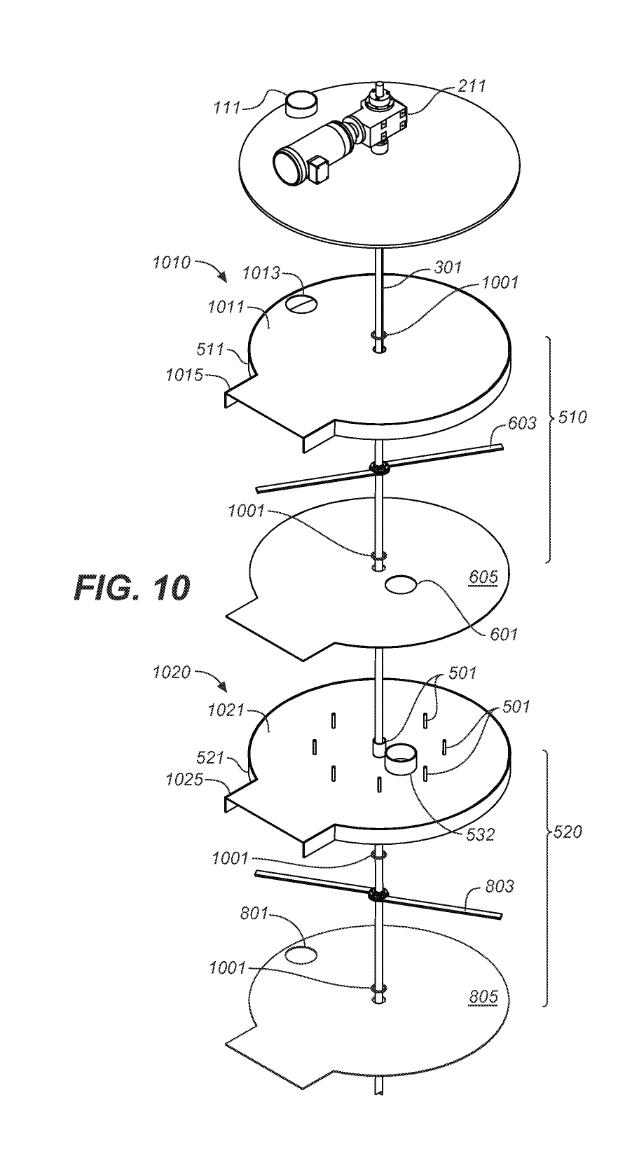

Trays 510 and 520 are shown in greater detail in FIGS. 6-10, where FIG. 6 is a sectional view 6-6 of heater tray 510 of FIG. 5, FIG. 7 is a sectional view 7-7 the region between two heater trays 510, 520 of FIG. 5, FIG. 8 is a sectional view 8-8 of heater tray 520 of FIG. 5, FIG. 9 is a sectional view 9-9 the region between two heater trays 520, 510 of FIG. 5, and FIG. 10 is an exploded sectional view of a portion of heater 120.

The interior of trays 510 and 520 are shown in FIGS. 6, 8, and 10. As shown in FIG. 10, tray 510 includes an upper portion 1010 that includes an upper wall 1011 having a hole 1013, outer perimeter 511, and portion 1015 that transitions to port 212, and tray 520 includes an upper portion 1020 that includes an upper wall 1021, outer perimeter 521, and portion 1025 that transitions to port 212. As shown in FIGS. 6 and 8, each tray 510, 520 includes a hole 601, 801, respectively through which material M may exit the tray, a paddle 603, and 803, respectively, that is configured to move the material to hole 601, 801, and a bottom 605, 805, on which the material moves.

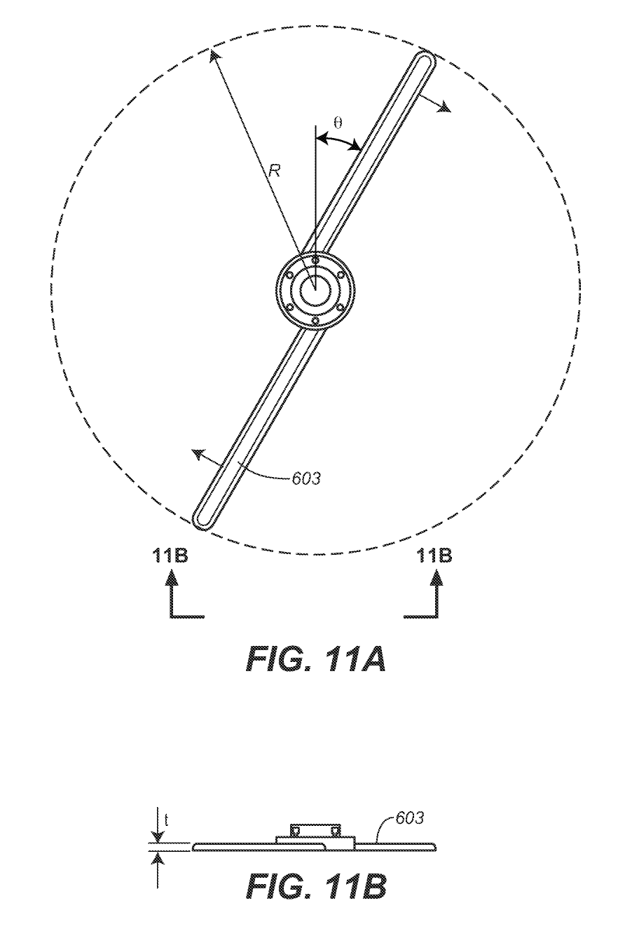

Paddles 603, 803 move in the same direction, but are oriented relative to shaft 301 to move material toward the differently located holes. The orientation of paddle 603 is shown in FIGS. 11A and 11B as a top and side view, respectively, of paddle 603 of the heater tray 510, and FIGS. 11C and 11D are a top and side view, respectively, of paddle 803 of the heater tray 520. The paddles have a height t of, without limitation of ¼ to 2 inches, and a length R equal to just short of the radius RT of the tray. The paddles and are offset to sweep material into holes 601, 801, respectively. Shaft 301 is sealed with seals 1001 at each surface it crosses, which may include seals into and out of trays 510 and 520, using methods well known in the art, to keep fluid F and material M separate within heater 110.

The space between trays 510, 520, through which fluid F flows in volume 114, is shown in FIGS. 7 and 9. Spacing elements 501 are used to provide structural support to the trays.

In one embodiment, furnace 100 is sized to process 1000 kg/hr of wood chips. Trays 510 and 520 have a height H of 100 mm, and a radius RT of 1.8 m, and are spaced apart by a distance S of 50 mm. The heater has a radius of RH of 1.9 m, providing a gap RH-RT of 0.1 m for fluid F. Paddle drive 211 is operated to urge the material from one tray to another. In one embodiment, the angle θ is 30 degrees, oriented to move the material towards the open holes at the bottom of trays 510 and 520, and is rotated at 60 rpm.

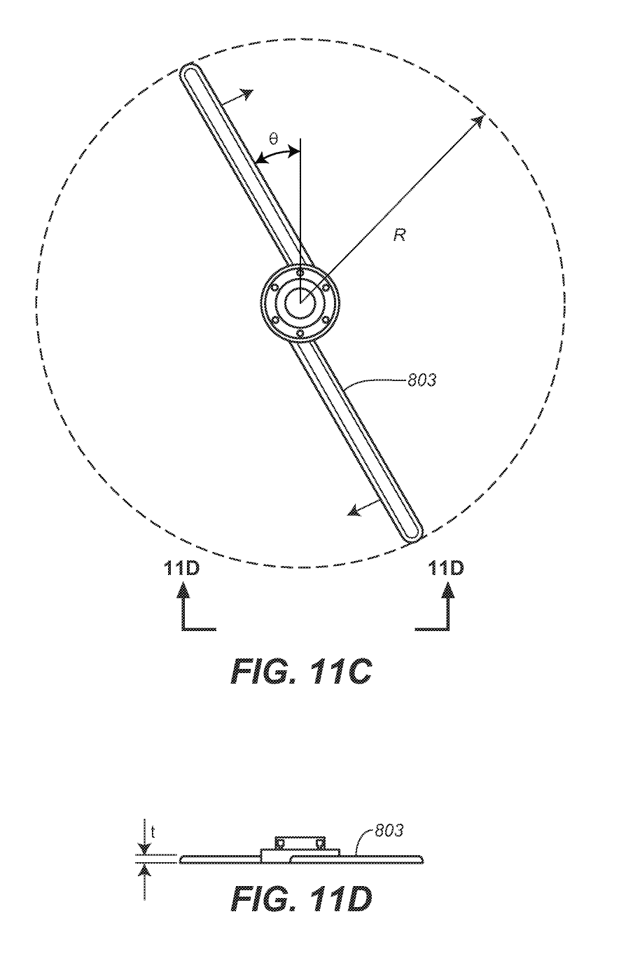

FIG. 12 is a sectional view 12-12 of the vaporizer of FIG. 4. Tubes 203 and 205 are pipes for transport of fluid F, which may flow through ports 121 and 123, and then through individual tubes 225.

The operation of furnace 100 is illustrated with reference FIGS. 1-12. Furnace 100 may be started by system 10 turning on blower 103, turning off valve 109, and providing an auxiliary fuel to burner 141. Combustion products generated in burner 141 are then provided to vaporizer 120, where they flow through pipes 125, heating heat exchanger fluid F, and exiting the vaporizer at port 123. The cooler gases then flow through preheater 130, where heat is exchanged with air from blower 101, when that blower is operated.

Eventually, the temperature of gas entering port 121 is hot enough to vaporize heat exchanger fluid F, and vapor rises from volume 122 of vaporizer 120 into volume 114 of heater 110. When the temperature Tv, as measured by diagnostics 155, reaches a set point, furnace 100 is ready to process material M. Blower 101 and paddle drive 211 are turned on by system 10 and material M is provided to input 110. As material M flows through volume 112, it is heated and gives off gases that may be recovered. Material M preferably will generate volatile gases which are recovered at port 117 and provided for mixing with preheated air from blower 101 in thermal oxidizer 143, and the products of oxidization are mixed with those of burner 141 and provided back to vaporizer 120.

In certain embodiments, furnace 100 is controlled by system 10. Thus, for example, if a sufficient amount of combustible gases are provided to thermal oxidizer 143, then system 10 may reduce the flow of auxiliary fuel 102, or shut off the auxiliary fuel and blower 103. If too much heat is generated in heat source 140, then valve 109 may be partially or fully opened to release heat from furnace 100. Process parameters determined by diagnostic 160 may be used to increase or decrease heat and/or material flow to maintain desired conditions.

In certain operating conditions, for instance torrefying a material M that is dry wood, at between 250° C. and 300° C. with a residence time of between 5 and 30 minutes, the product gas has more chemical energy than required by the heating process. If heat is not removed from the system, then the process throughput will be limited, as will the allowable process set points. For oily feedstocks, with rapid processing rates, chemical energy is in significant excess, and recovering this energy is attractive.

A critical aspect of the indirect heated roaster of heater 110 is the handling of the process off gases, which may contain condensable hydrocarbons (CxHyOz), steam, non-condensable gases, and particulates. A second critical aspect are the methods to provide an oxygen free process, while preventing all off gas leakage to atmosphere. In the present invention, volume 112 of heater 110 can be operated at either ambient pressure, or slightly above ambient pressure (i.e. 4 inches H₂O), or slightly below ambient pressure. In a preferred embodiment, volume 112 is operated at slightly above the pressure of thermal oxidizer, promoting flow from the volume into heat source 140.

Examples of the conditions required for torrefaction of materials is described in the related '497, '356, and '157 applications. More specifically, the following is a table of operating conditions for different feedstock materials M.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby expressly incorporated into this description, with each claim standing on its own as a separate embodiment of this invention.

What is claimed:

1. A furnace having an input adapted to accept a material to be processed, an output adapted to provide processed material, said furnace comprising:
a first volume for containing a fluid, where said fluid is a phase-change heat-transfer fluid, and where said fluid includes a vapor of said fluid and a liquid of said fluid; and
a second volume for containing the material to be processed;
where said first volume and said second volume have a separating wall that is a fluid barrier between said first volume and said second volume and which provides for heat transfer between condensing vapor of said fluid and material contained within said second volume, and
where said second volume includes at least two trays, where said at least two trays are substantially horizontal and disposed at different vertical heights, and at least one passageway between two of said at least two trays.

2. The furnace of claim 1, where the furnace is operated at a pressure greater than atmospheric pressure.

3. The furnace of claim 1, where the material is gravity feed from one tray to the next tray.

4. The furnace of claim 1, where at least one of said at least two trays includes a moving element to facilitate material movement through said tray.

5. The furnace of claim 1, where said moving element is a rotating paddle.

6. The furnace of claim 1, where a liquid-phase condensate is recovered from the processed material.

7. The furnace of claim 1, where a combustible mixture is recovered from the processed material.

8. The furnace of claim 1, where said furnace further comprises a vaporizer, where said vaporizer collects said liquid of said fluid, and where heat is provided to said liquid of said fluid in said vaporizer to vaporize said liquid of said fluid.

9. The furnace of claim 7, further including:
a device to generate heat from the combustible mixture, and
a vaporizer to collect said liquid of said fluid,
where heat from the device is provide to said vaporizer, where the heat vaporizes said phase-change heat-transfer fluid.

10. The furnace of claim 1, where said vaporizer includes a tube bundle to remove heat from said fluid.

11. The furnace of claim 1, where the processed material is densified.

12. A method of torrefying a material using a fluid, where the fluid is a phase-change heat-transfer fluid and includes a liquid phase of the fluid and a vapor phase of the fluid, said method comprising:
providing the material sequentially to at least two trays, where said at least two trays are substantially horizontal and disposed at different vertical heights;
condensing the vapor phase at a temperature; and
providing heat from said condensing the vapor phase to the material,
where said temperature is sufficient to torrefy the material.

13. The method of claim 12, where the material is at a pressure greater than atmospheric pressure.

14. The method of claim 12, where the providing the material sequentially to at least two trays includes gravity feeding the material from one tray to the next tray.

15. The method of claim 12, further comprising moving an element to facilitate movement of the material through said trays.

16. The method of claim 15, where said moving includes rotating a paddle.

17. The method of claim 12, further comprising recovering a liquid-phase condensate from the torrefying material.

18. The method of claim 12, further comprising recovering a combustible mixture from the torrefied material.

19. The method of claim 18, further comprising
collecting the liquid phase of the fluid,
generating heat from the recovered combustible mixture, and
utilizing the heat to vaporize the liquid phase of the fluid.

20. The method of claim 19 further comprising removing excess heat from the fluid.
